(19) United States
(12) Patent Application Publication
(10) Pub. No.: US 2002/0170500 A1
(43) Pub. Date: Nov. 21, 2002

(54) Hydrolyzable metal salt mixtures for use with animal litter and bedding

(76) Inventors: Christopher B. Lind, Syracuse, NY (US); Gregory N. Armstrong, Suwanee, GA (US)

Correspondence Address: Arthur J. Plantamura, Esq., General Chemical Corporation, 90 East Halsey Road, Parsippany, NJ, 07954, US

(21) Appl. No.: 09/861,809

(22) Filed: May 21, 2001

(51) Int. Cl. A01K 29/00

(52) U.S. Cl. 119/171

(57) ABSTRACT

Animal bedding materials are pre-mixed with a dry blend or a solution of a hydrolyzable metal salt using a mechanical mixer. Ammonia control is more uniform and pH is reduced. Further, pre-mixing improves worker safety due to dust and corrosive chemical reduction in the atmosphere of animal enclosures.

This invention relates to improvements in the treatment of animal litter and bedding to reduce the generation of ammonia, which has a deleterious effect on animal health and rate of growth.

### BACKGROUND OF THE INVENTION

Moore, Jr., in a series of U.S. Patents, has explained that animal litter or manure, particularly from farm animals such as poultry and pigs, contains ammonia and phosphates. The amounts of ammonia given off into the atmosphere of an animal enclosure adversely affects farm workers, and even the animals themselves. When large amounts of ammonia are present in an animal enclosure, the result is lower weight gain and higher mortality rates for the animals.

Thus alum (aluminum sulfate), having the formula

Al₂(SO₄)₃.nH₂O

wherein n is above 1 and typically is about 14-18, has been used to reduce the pH, and thus the ammonia generation, of manure and animal bedding material. Alum, either in solid or liquid form, will lower the pH of the manure by hydrolysis and will convert ammonia to ammonium ions. Ammonium ions will react with sulfates to form ammonium sulfate; the latter is a water soluble nitrogen fertilizer and can be used as such. Desirably, the amount of ammonia present in the atmosphere of an animal enclosure should be held below about 25 ppm.

The use of alum for maintaining a low ammonia content has an added advantage in that the soluble phosphates present precipitate in the presence of aluminum, and thus the soluble phosphate content of manure is also reduced by this treatment. Soluble phosphates are known to seep into ground water or are carried in surface runoff water. In either case, this presents a substantial environmental problem. Gaseous ammonia emission is also an air quality environmental problem. The insoluble phosphates thus reduce environmental concerns as well.

It is recognized that dry alum can require up to two weeks to absorb sufficient water from the air or surrounding litter to initiate the reduction of the pH of the litter to thereby reduce gaseous ammonia emissions. And, although alum can also be mixed with water and sprayed onto manure and bedding material present in an enclosure, in an effort to accelerate its function, this method of application may be more difficult to apply uniformly onto litter.

A more uniform method of distributing alum throughout bedding material would offer faster ammonia control and reduction of pH. Thus an improved method of combining alum or other suitable materials to expedite the initiation of the pH reduction, i.e., to reduce ammonia production of animal bedding material and provide uniformity, would be highly advantageous.

### SUMMARY OF THE INVENTION

Animal litter and bedding material is treated with, or integrated into, a hydrolyzable metal salt or acidic compound prior to placement in an animal enclosure. A solution of the hydrolyzable metal salt is thoroughly mixed with bedding material by mechanical means at a rate of about 30 to 120 gallons of aqueous solution, based on a 50% by weight solution, per ton of animal bedding material. A premix of dry hydrolyzable metal salt can be uniformly pre-mixed with the bedding material to form an integrated composition which, after application, may optionally be moistened to hasten the functioning of the metal salt to reduce the ammonia generation. Such a premix composition that gives good results comprises a mixture of from 50-250 pounds/1000 square feet of bedding.

However, by applying the hydrolyzable salt solution directly to the bedding material, a more uniform distribution offering faster ammonia control, and reduced pH, can be obtained. Further, this provides a one-step approach for bedding material placement that has the added advantage of reducing dust and improving worker safety.

### DETAILED DESCRIPTION OF THE INVENTION

Suitable hydrolyzable metal salts that are useful herein include alum, in dry or liquid form; aluminum chloride; dry sulfuric acid salts such as sodium bisulfate; hydrochloric acid; ferric sulfate or ferric chloride, dry or as a solution; ferrous sulfate is also suitable. Liquid alum is generally used as a nearly 50% by weight solution in water, and aluminum chloride is used as a more dilute solution containing about 30% by weight or less of alum. Ferric chloride can be added at about a 42% by weight solution; ferric sulfate can be added at about a 60% by weight solution. The above concentrations of solution are suitable, but other concentrations can be used.

Typical animal bedding materials include rice hulls, wood shavings, sawdust, secondary paper, nut hulls, bran hulls, wood chips and sand. Other materials are known to those skilled in the art.

In an example of how the present invention can be used, using pine shavings as a poultry litter base, liquid alum, i.e., a 50% by weight solution of dry alum, is added at a rate of about 30 to 120 gallons of alum solution per ton of shavings, in a compost mixer. This pre-mix composition is applied to an animal enclosure as bedding material.

Dry alum can be substituted in amounts corresponding to about 50 to 250 pounds per 1000 square feet of bedding material. Water could be added just prior to use, or as needed for homogeneity of the mixture.

The advantages of pre-mixing of a hydrolyzable metal salt and bedding materials are several; a more uniform distribution of the metal salt throughout the bedding can be achieved, resulting in a more expeditious ammonia control action and pH depression; the pH depression is longer lasting in terms of animal health and performance; the grower does not have to handle acidic, corrosive chemicals, and only has to handle the material once. The pre-addition of a hydrolyzable metal salt solution means there is less dust generation and thus less corrosive material entering the atmosphere of the animal enclosure, with a concomitant increase in worker safety, and longer lasting effects on moisture control. In addition, phosphorus is more uniformly bound throughout the litter matrix, and a more uniform pathogen control is achieved as well.

Thus the addition of a hydrolyzable metal salt to bedding materials prior to use in an animal enclosure provides many benefits and advantages.

The present bedding material can be used for housing animals including poultry, such as chickens, turkeys and ducks, cattle, lambs, rabbits and rodents. The present pre-mixed hydrolyzable salt-bedding mixture can also be added to pre-existing bedding materials.

Although the invention has been described in terms of specific additives and amounts, other additives can be added and other bedding materials can be used, as will be known to one skilled in the art. Thus the invention is only meant to be limited by the scope of the appended claims.

We claim:

1. A method of reducing ammonia generation in animal enclosures comprising
mechanically mixing a hydrolyzable metal salt with animal bedding material prior to application in an animal enclosure.

2. A method according to claim 1 wherein said metal salt is alum.

3. A method according to claim 1 wherein said metal salt is a 50% by weight solution of alum.

4. A method according to claim 3 wherein from 30 to about 120 gallons of alum solution is added to about one ton of bedding material.

5. A method according to claim 1 wherein said metal salt is aluminum chloride.

6. A method according to claim 2 wherein the alum is in dry form in amounts of from about 5% to about 20% by weight based on the weight of the bedding.

7. A method according to claim 2 wherein from about 50 to about 250 pounds of alum is mixed with about 1000 square feet of bedding material.

8. A method according to claim 5 wherein said aluminum chloride
is applied as a 30% by weight solution

9. A method according to claim 1 wherein the hydrolyzable metal salt is ferric sulfate solution at about 60% by weight solution strength.

10. A method according to claim 1 wherein the hydrolyzable metal salt is dry ferric sulfate.

11. A method according to claim 1 wherein the hydrolyzable metal salt is ferrous sulfate solution.

12. A method according to claim 1 wherein the hydrolyzable metal salt is dry ferrous sulfate.

13. A method according to claim 1 wherein the hydrolyzable metal salt is ferric chloride solution at about 42% by weight solution strength.

14. A composition of matter comprising an integrated mixture of a hydrolyzable metal salt and animal bedding material.

15. A composition according to claim 14 wherein said metal salt is alum.

16. A composition according to claim 14 wherein the hydrolyzable salt is aluminum chloride.

17. A composition of matter according to claim 14 wherein the hydrolyzable metal salt is ferric sulfate.

18. A composition of matter according to claim 14 wherein the hydrolyzable salt is ferrous sulfate.

19. A premix composition for reducing ammonia generation in animal enclosures comprising an integrated mixture of a hydrolyzable metal salt and animal bedding material.

20. A premix composition according to claim 19 wherein said metal salt is alum.

21. A premix composition according to claim 20 wherein from about 50 to about 250 pounds of alum is mixed with about 1000 square feet of animal bedding material.

22. A premix composition according to claim 20 wherein said metal salt is added as a 50% by weight aqueous solution of alum mixed with animal bedding material.

23. A premix composition according to claim 23 wherein from about 30 to 120 gallons of said solution are added to about one ton of animal bedding material.
